(19) United States
(12) Patent Application Publication
(10) Pub. No.: US 2014/0074691 A1
(43) Pub. Date: Mar. 13, 2014

(54) BILL SPLIT FOR NFC TRANSACTIONS

(71) Applicants: JUDITH H. BANK, MORRISVILLE, NC (US); LIAM HARPUR, SKERRIES (IE); RUTHIE D. LYLE, DURHAM, NC (US); PATRICK J. O'SULLIVAN, BALLSBRIDGE (IE); LIN SUN, MORRISVILLE, NC (US)

(72) Inventors: JUDITH H. BANK, MORRISVILLE, NC (US); LIAM HARPUR, SKERRIES (IE); RUTHIE D. LYLE, DURHAM, NC (US); PATRICK J. O'SULLIVAN, BALLSBRIDGE (IE); LIN SUN, MORRISVILLE, NC (US)

(73) Assignee: INTERNATIONAL BUSINESS MACHINES CORPORATION, ARMONK, NY (US)

(21) Appl. No.: 13/611,469

(22) Filed: Sep. 12, 2012

(51) Int. Cl. G06Q 20/32

(52) U.S. Cl. 705/39

(57) ABSTRACT

Conducting a financial transaction using near field communication. An amount of money owed for a first commercial transaction can be determined. Respective financial account information can be received from each of a plurality of mobile devices via near field communication. A respective portion of the money owed for the first commercial transaction can be allocated to each respective financial account, wherein each respective financial account is identified by the financial account information provided by a respective one of the plurality of mobile devices. Allocated portions of the money owed can be charged, respectively, to the financial accounts.

### BACKGROUND

Near field communication (NFC) is a means of communication in which a mobile device establishes radio communication with another device, for example by touching the mobile device to the other device, or bringing the mobile device in close proximity to the other device (e.g., within a few centimeters). The other device can be, for example, a point-of-sale terminal, a kiosk or another mobile device. Applications of NFC include, but are not limited to, data exchange and financial transactions. In illustration, a user can use NFC to make payment in a commercial transaction from the user's mobile device. More particularly, via NFC, the user can communicate financial information, such as credit card or debit card information, from the mobile device to another device. Thus, the user need not carry an actual credit card or debit card, while still being able to use an associated financial account to make payments.

### BRIEF SUMMARY

One or more embodiments disclosed within this specification relate to conducting a financial transaction using near field communication.

An embodiment can include a method of conducting a financial transaction using near field communication. The method can include determining an amount of money owed for a first commercial transaction, and receiving from each of a plurality of mobile devices, via near field communication, respective financial account information. The method also can include allocating to each respective financial account, via a processor, a respective portion of the money owed for the first commercial transaction, wherein each respective financial account is identified by the financial account information provided by a respective one of the plurality of mobile devices. The method further can include charging, to each of the respective financial accounts, the respective allocated portion of the money owed.

Another embodiment can include a system including a processor configured to initiate executable operations. The executable operations can include determining an amount of money owed for a first commercial transaction, and receiving from each of a plurality of mobile devices, via near field communication, respective financial account information. The executable operations also can include allocating to each respective financial account a respective portion of the money owed for the first commercial transaction, wherein each respective financial account is identified by the financial account information provided by a respective one of the plurality of mobile devices. The executable operations further can include charging, to each of the respective financial accounts, the respective allocated portion of the money owed.

Another embodiment can include a computer program product for conducting a financial transaction using near field communication. The computer program product can include a computer-readable storage medium having stored thereon program code that, when executed, configures a processor to perform operations. The executable operations can include determining an amount of money owed for a first commercial transaction, and receiving from each of a plurality of mobile devices, via near field communication, respective financial account information. The executable operations also can include allocating to each respective financial account a respective portion of the money owed for the first commercial transaction, wherein each respective financial account is identified by the financial account information provided by a respective one of the plurality of mobile devices. The executable operations further can include charging, to each of the respective financial accounts, the respective allocated portion of the money owed.

### BRIEF DESCRIPTION OF THE SEVERAL VIEWS OF THE DRAWINGS

FIG. 1 is a block diagram illustrating a system for conducting a financial transaction using near field communication in accordance with one embodiment disclosed within this specification.

FIG. 2 is a block diagram illustrating a commercial transaction processing system in accordance with an embodiment disclosed within this specification.

FIG. 3 is a flow chart illustrating a method of conducting a financial transaction using near field communication in accordance with an embodiment disclosed within this specification.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied, e.g., stored, thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

Arrangements described herein relate to conducting a commercial transaction using near field communication. As used herein, the term near field communication (hereinafter “NFC”) means short range wireless communication via interacting electromagnetic fields in lieu of direct radio transmissions. The range of NFC generally is limited to a maximum distance of 10 cm, and oftentimes is limited to a maximum distance of 3 or 4 cm. NFC does not involve use of a magnetic strip, such as that contained on a traditional credit card or debit card. Instead, NFC uses NFC tags, typically comprising an NFC chip and an antenna. Further, NFC does not require an exchange of discovery and pairing information commonly used in communication protocols such as Bluetooth® and WiFi™.

To implement the commercial transaction using NFC, a commercial transaction processing system can communicate with a plurality of mobile devices via NFC to receive financial information that is processed to make payments for the commercial transaction. The commercial transaction can involve a plurality of users, each of whom desire to pay a portion of money owed in the commercial transaction via their respective mobile devices using NFC. The money owed can be determined by the commercial transaction processing system, or another device or system to which the commercial transaction processing system is communicatively linked.

The commercial transaction processing system can receive from each of the plurality of mobile devices, via NFC, information identifying respective financial accounts, and allocate to each of the respective financial accounts a respective portion of the money owed for the commercial transaction. The commercial transaction processing system can charge, to each of the respective financial accounts, the respective allocated portion of the money owed. Accordingly, the money owed can be divided among the plurality of users, while allowing the users to pay their respective portions of the money owed using their respective mobile devices.

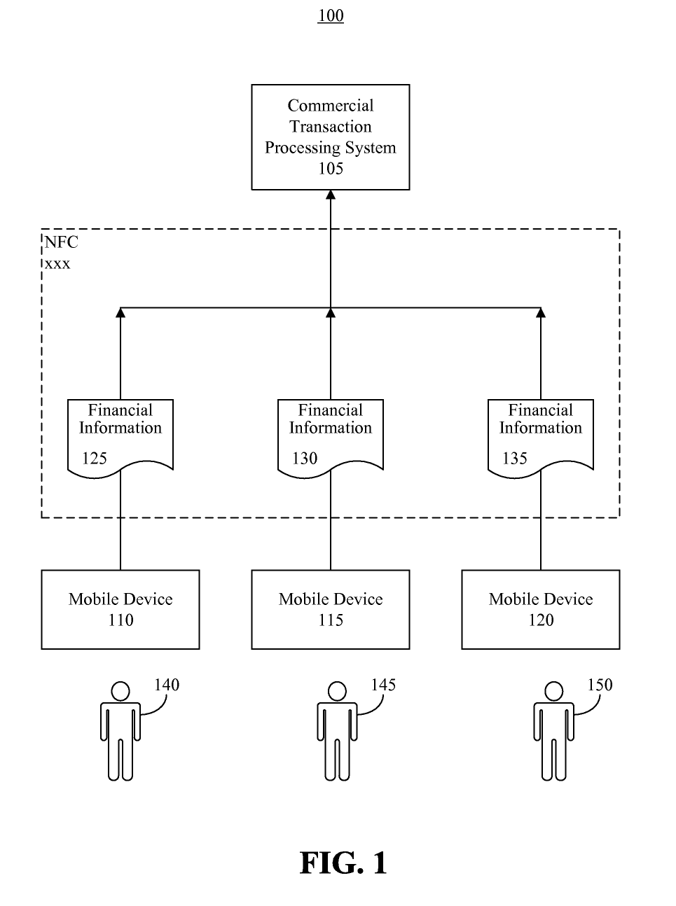

FIG. 1 is a block diagram illustrating a system 100 for conducting a financial transaction using NFC in accordance with one embodiment disclosed within this specification. The system 100 includes a commercial transaction processing system (hereinafter “processing system”) 105 and a plurality of mobile devices 110, 115, 120. The processing system 105 can be a point-of-sale terminal, a kiosk, another mobile device, or any other system or device configured to communicate with the mobile devices 110-120 via NFC to receive financial information 125, 130, 135. The mobile devices 110-120 can be smart phones, personal digital assistants, powered NFC devices, unpowered NFC devices, cards including powered NFC tags, cards including unpowered NFC tags, or any other portable devices configured to communicate information via NFC. Each of the mobile devices 110-120 can be used by, and thus associated with, a respective user (i.e., person) 140, 145, 150 to make payments in a commercial transaction as described herein.

In operation, the processing system 105 can determine an amount of money owed for a commercial transaction. For example, a plurality of users 140, 145, 150 can be dining at a particular restaurant. A server can enter information corresponding to food and beverages served to the users 140-150 into the processing system 105 or another device communicatively lined to the processing system 105. When the dining experience is complete, and it is time to for the users to pay their tab, each of the users 140-150 can communicate their respective financial account information to the processing system 105 via NFC using their respective mobile devices 110-120. The financial account information provided by each user 140-150 can identify at least one financial account the user 140-150 desires to use to make payment toward their portion of the bill (or tab). The processing system 105 can allocate to each respective financial account a respective portion of the money owed for this commercial transaction, and charge to each of the respective financial accounts the respective allocated portion of the money owed.

In one arrangement, the processing system 105 can equally divide the amount of the bill among the users 140-150, and thus allocate to the respective financial accounts of the users 140-150 respective portions of the bill. In one aspect, upon allocation, the processing system 105 can automatically charge the respective financial accounts for the respective portions of the money owed. In another aspect, the processing system 105 can communicate to the mobile devices 110-120 the respective portions of the bill, and the mobile devices 110-120 can prompt the respective users 140-150 to accept or deny the charges. The mobile devices 110-120 can communicate the user responses to the processing system 105. Such communications can be performed via NFC, or another communication protocol, for example WiFi™ or Bluetooth®.

In another arrangement, the processing system 105 can receive from at least one of the mobile devices 110-120 information indicating a manner in which the money owed is to be allocated among a plurality of users 140-150. The receive information can indicate categories of charges allocated among the plurality of users 140-150, though this need not be the case. Such information can be communicated via NFC or another suitable communication protocol.

For example, the processing system 105 can communicate the bill to one or more of the mobile devices 110-120, via NFC or another communication protocol. The bill can categorize various charges for the commercial transaction based on groups of one or more users, portions of the meal (e.g., appetizers, main courses, deserts, etc.), or any other suitable categories. In this regard, the commercial transaction can be a multi-category purchase. One or more of the users 140-150 can review the categories and indicate a manner in which the money owed is to be allocated among the plurality of users 140-150. Based on the received allocation, the processing system 105 can allocate to the respective financial account of each user 140-150 the respective portion of the money owed for the commercial transaction. Again, the processing system 105 can automatically charge the respective financial accounts for the respective portions of the money owed upon the received allocation, or do so when confirmation is received from each of the respective users 140-150.

Responsive the money owed being processed for the plurality of financial accounts, the processing system 105 can communicate to one or more of the mobile devices 110-120 one or more receipts for the commercial transaction. For a particular mobile device 110-120, the receipt can indicate a respective amount of money charged in the commercial transaction to the financial account identified by the financial account information provided by the respective mobile device 110-120. Further, the receipt can indicate a summary indicating a plurality of purchase categories and an amount of money charged to the respective financial account for each purchase category. Moreover, the receipt can indicate an amount of money charged in the commercial transaction to each user 140-150. As noted, each user 140-105 can be associated with a respective one of the financial accounts. The receipt(s) need not disclose the financial account information, or can merely indicate the last three or four digits of the financial account numbers.

The processing system 105 can maintain a history of commercial transactions. More particularly, the processing system 105 can maintain a history of commercial transactions regarding groups of users, such as the users 140-150. Accordingly, the processing system 105 can apply this historical information to determine how to allocate money owed by the users 140-150 in future transactions. In illustration, the processing system 105 can determine an amount of money owed for a second commercial transaction involving the users 140-150. Again, the processing system 105 can receive from each of the plurality of mobile devices 110-120, via NFC, the respective financial account information of the users 140-150 from the respective mobile devices 110-120. Based on the allocation of the money owed in one or more previous commercial transaction among the plurality of users 140-150, the processing system 105 can allocate to each respective financial account a respective portion of the money owed for the present commercial transaction. The information indicating how respective portions of the money owed for the previous commercial transaction(s) were allocated can be stored, and thus retrieved, locally. In another arrangement, such information can be stored to, and retrieved from, a server to which the processing system 105 is communicatively linked.

In some instances, the charges to the financial account(s) of one or more users 140-150 may be declined. In such case, the processing system 105 can indicate the charge(s) was/were declined. For example, a message can be presented to a user (e.g., a server or a clerk) of the processing system 105 prompting the user to request another financial account, or another form of payment, from the user(s) 140-150 whose charges was/were declined. In illustration, if the charges allocated to the user 140 were declined, the clerk or server can ask the user 140 to provide financial account information for another financial account via NFC, provide a conventional credit card or debit card, or to provide a check or cash. In another arrangement, the commercial transaction processing system 105 can reallocate the charges among the users 145-150 whose charges were not declined, for example if such users 145-150 authorized such reallocation. The receipt(s) provided to the users 140-150 can indicate the updated charge allocations.

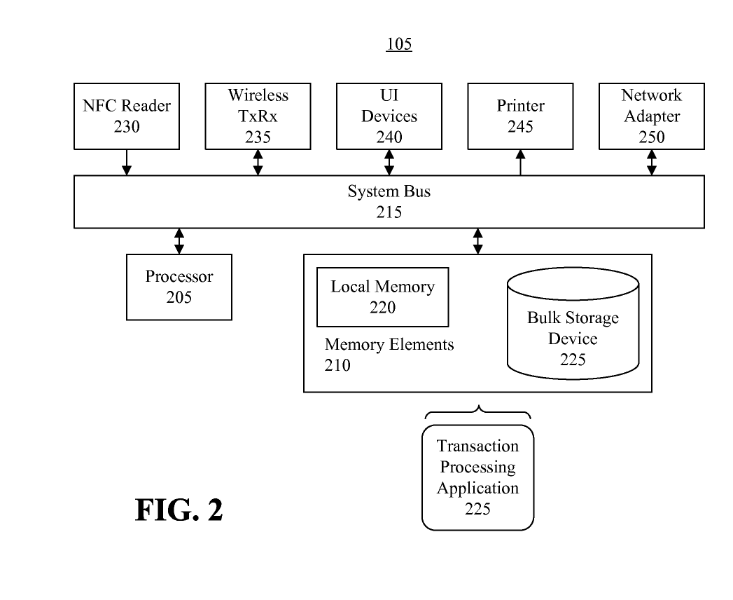

FIG. 2 is a block diagram illustrating a commercial transaction processing system (hereinafter “processing system”) 105 in accordance with an embodiment disclosed within this specification. The processing system 105 can include at least one processor 205 coupled to memory elements 210 through a system bus 215 or other suitable circuitry. As such, the processing system 105 can store program code within the memory elements 210. The processor 205 can execute the program code accessed from the memory elements 210 via the system bus 215. It should be appreciated that the processing system 105 can be implemented in the form of any system including a processor and memory that is capable of performing the functions and/or operations described within this specification. For example, the processing system 105 can be implemented as a computer, a workstation, a mobile computer, a laptop computer, tablet computer, a smart phone, a personal digital assistant, a gaming device, an appliance, and so on.

The memory elements 210 can include one or more physical memory devices such as, for example, local memory 220 and one or more bulk storage devices 225. Local memory 220 refers to RAM or other non-persistent memory device(s) generally used during actual execution of the program code. The bulk storage device(s) 225 can be implemented as a hard disk drive (HDD), solid state drive (SSD), or other persistent data storage device. The processing system 105 also can include one or more cache memories (not shown) that provide temporary storage of at least some program code in order to reduce the number of times program code must be retrieved from the bulk storage device 225 during execution.

An NFC reader 230 is coupled to the processing system 105, for example via the system bus 215 and/or an intervening Input/output (I/O) controller. The NFC reader 230 is configured to receive data, such as financial account information, from the mobile devices using NFC. Optionally, the NFC reader 230 also can be configured to send data to the mobile devices using NFC. For example, the NFC reader 230 can send to one or more of the mobile devices a bill (or tab), suggested allocations of portions of the bill to various users, one or more receipts, etc.

A wireless transceiver (hereinafter “transceiver”) 235 also can be coupled to the processing system 105, for example via the system bus 215 and/or an intervening Input/output (I/O) controller. The transceiver 235 can communicate via WiFi™, Bluetooth®, and/or any other suitable wireless communication protocol. In an arrangement in which the processing system 105 is a mobile device, the processing system 105 can communicate with another processing system, such as a server, via the transceiver 235. In illustration, the processing system 105 can send to the other processing system financial account information received via the NFC reader 230, and the other processing system can process the financial account information to receive payment for the bill. In another arrangement, the processing system 105 can be configured to process the financial account information to receive the payment.

User interface (UI) devices 240 can be coupled to the processing system 105. The UI devices 240 can be coupled to the processing system 105 either directly or through intervening I/O controllers. Examples of UI devices 240 include, but are not limited to, a display, a touchscreen, buttons, keys, a keypad, a keyboard and pointing device (e.g., a mouse, touchpad, or the like). Optionally, a printer 245 can be coupled to the processing system 105. The printer 245 can be used to print bills, receipts, etc., from the processing system 105. One or more network adapters 250 also can be coupled to processing system 105 to enable processing system 105 to become coupled to other systems, computer systems, remote printers, and/or remote storage devices through intervening private or public networks. Modems, cable modems, and Ethernet cards are examples of different types of network adapters 250 that can be used with processing system 105.

As pictured in FIG. 2, the memory elements 210 can store a transaction processing application 255. Being implemented in the form of executable program code, the transaction processing application 255 can be executed by the processing system 105 and, as such, can be considered part of the processing system 105. The transaction processing application 255 can be executed by the processor 205 to generate bills, allocate portions of bills amount multiple users, receive financial account information, process the financial account information (or forward such information to another processing system), generate receipts, and so on, as described herein.

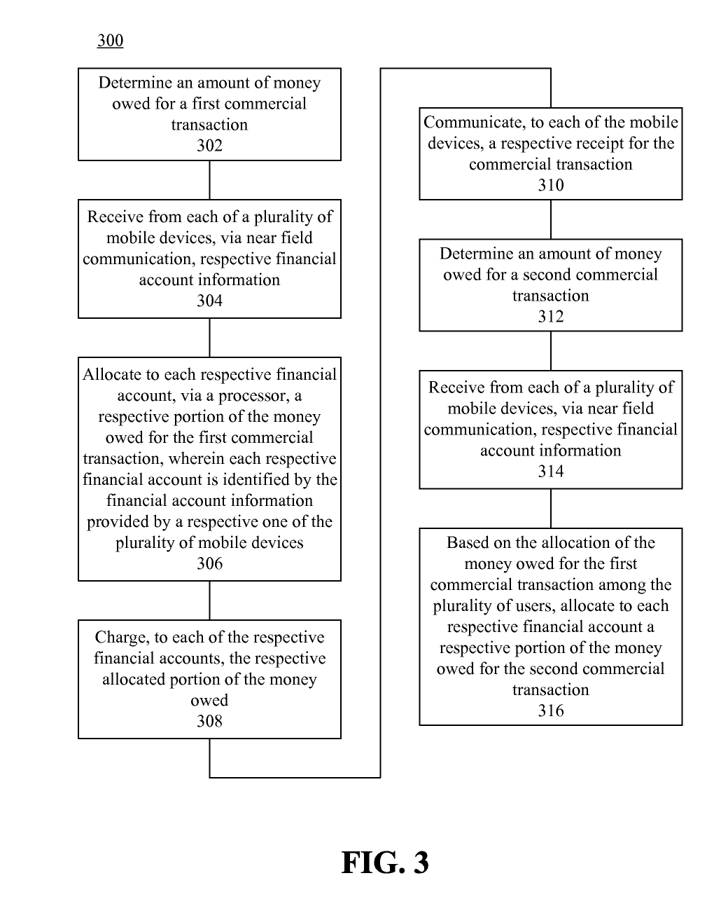

FIG. 3 is a flow chart illustrating a method 300 of conducting a financial transaction using near field communication in accordance with an embodiment disclosed within this specification. At step 302, an amount of money owed for a first commercial transaction can be determined. At step 304, respective financial account information can be received from each of a plurality of mobile devices via near field communication.

At step 306, via a processor, a respective portion of the money owed for the first commercial transaction can be allocated to each respective financial account. Each respective financial account can be identified by the financial account information provided by a respective one of the plurality of mobile devices. In one arrangement, information can be received from at least one of the mobile devices indicating a manner in which the money owed is to be allocated among a plurality of users, each of the plurality of users associated with a respective one of the plurality of mobile devices.

At step 308, the respective allocated portions of the money owed can be charged the respective financial accounts. At step 310, a respective receipt for the commercial transaction can be communicated to each of the mobile devices. In one arrangement, each respective receipt can indicate the respective amount of money charged in the first commercial transaction to the financial account identified by the financial account information provided by the respective mobile device. Further, the receipt can indicate a summary of a multi-category purchase, wherein the summary indicates a plurality of purchase categories and an amount of money charged to the respective financial account for each purchase category. In another arrangement, each receipt can indicate a total amount of money charged in the first commercial transaction. Each receipt further can indicate an amount of money charged in the first commercial transaction to each user, each user associated with a respective one of the financial accounts.

At some point in time, the users may again initiate a commercial transaction at the same establishment. At step 312, an amount of money owed for a second commercial transaction can be determined. At step 314, respective financial account information can be received from each of a plurality of mobile devices via near field communication. At step 316, based on the allocation of the money owed for the first commercial transaction among the plurality of users, a respective portion of the money owed for the second commercial transaction can be allocated to each respective financial account.

Like numbers have been used to refer to the same items throughout this specification. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Reference throughout this specification to “one embodiment,” “an embodiment,” or similar language means that a particular feature, structure, or characteristic described in connection with the embodiment is included in at least one embodiment disclosed within this specification. Thus, appearances of the phrases “in one embodiment,” “in an embodiment,” and similar language throughout this specification may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The corresponding structures, materials, acts, and equivalents of all means or step plus function elements in the claims below are intended to include any structure, material, or act for performing the function in combination with other claimed elements as specifically claimed. The description of the embodiments disclosed within this specification have been presented for purposes of illustration and description, but are not intended to be exhaustive or limited to the form disclosed. Many modifications and variations will be apparent to those of ordinary skill in the art without departing from the scope and spirit of the embodiments of the invention. The embodiments were chosen and described in order to best explain the principles of the invention and the practical application, and to enable others of ordinary skill in the art to understand the inventive arrangements for various embodiments with various modifications as are suited to the particular use contemplated.

What is claimed is:

1. A method of conducting a financial transaction using near field communication, the method comprising:
determining an amount of money owed for a first commercial transaction;
receiving from each of a plurality of mobile devices, via near field communication, respective financial account information;
allocating to each respective financial account, via a processor, a respective portion of the money owed for the first commercial transaction, wherein each respective financial account is identified by the financial account information provided by a respective one of the plurality of mobile devices; and
charging, to each of the respective financial accounts, the respective allocated portion of the money owed.

2. The method of claim 1, further comprising:
communicating, to each of the mobile devices, a respective receipt indicating a respective amount of money charged in the first commercial transaction to the financial account identified by the financial account information provided by the respective mobile device.

3. The method of claim 2, wherein:
the receipt indicates a summary of a multi-category purchase, wherein the summary indicates a plurality of purchase categories and an amount of money charged to the respective financial account for each purchase category.

4. The method of claim 1, further comprising:
communicating, to each of the mobile devices, a receipt indicating a total amount of money charged in the first commercial transaction.

5. The method of claim 4, wherein:
the receipt further indicates an amount of money charged in the first commercial transaction to each user, each user associated with a respective one of the financial accounts.

6. The method of claim 1, wherein allocating to each respective financial account the respective portion of the money owed for the first commercial transaction comprises:
receiving information from at least one of the mobile devices indicating a manner in which the money owed is to be allocated among a plurality of users, each of the plurality of users associated with a respective one of the plurality of mobile devices.

7. The method of claim 6, wherein:
the received information indicates categories of charges allocated among the plurality of users.

8. The method of claim 1, further comprising:
determining an amount of money owed for a second commercial transaction;
receiving from each of the plurality of mobile devices, via a near field communication transceiver, the respective financial account information;
based on the allocation of the money owed for the first commercial transaction among the plurality of users, allocating to each respective financial account a respective portion of the money owed for the second commercial transaction.

9. The method of claim 8, wherein allocating to each respective financial account the respective portion of the money owed for the second commercial transaction comprises:
receiving from a server information indicating how respective portions of the money owed for the first commercial transaction were allocated among the plurality of the respective financial accounts.

10. A system comprising:
a processor configured to initiate executable operations comprising:
determining an amount of money owed for a first commercial transaction;
receiving from each of a plurality of mobile devices, via near field communication, respective financial account information;
allocating to each respective financial account a respective portion of the money owed for the first commercial transaction, wherein each respective financial account is identified by the financial account information provided by a respective one of the plurality of mobile devices; and
charging, to each of the respective financial accounts, the respective allocated portion of the money owed.

11. The system of claim 10, wherein the processor further is configured to initiate executable operations comprising:
communicating, to each of the mobile devices, a respective receipt indicating a respective amount of money charged in the first commercial transaction to the financial account identified by the financial account information provided by the respective mobile device.

12. The system of claim 11, wherein:
the receipt indicates a summary of a multi-category purchase, wherein the summary indicates a plurality of purchase categories and an amount of money charged to the respective financial account for each purchase category.

13. The system of claim 10, wherein the processor further is configured to initiate executable operations comprising:
communicating, to each of the mobile devices, a receipt indicating a total amount of money charged in the first commercial transaction.

14. The system of claim 13, wherein:
the receipt further indicates an amount of money charged in the first commercial transaction to each user, each user associated with a respective one of the financial accounts.

15. The system of claim 10, wherein the processor further is configured to initiate executable operations comprising:
receiving information from at least one of the mobile devices indicating a manner in which the money owed is to be allocated among a plurality of users, each of the plurality of users associated with a respective one of the plurality of mobile devices.

16. The system of claim 15, wherein:
the received information indicates categories of charges allocated among the plurality of users.

17. The system of claim 10, wherein the processor further is configured to initiate executable operations comprising:
determining an amount of money owed for a second commercial transaction;
receiving from each of the plurality of mobile devices, via a near field communication transceiver, the respective financial account information;
based on the allocation of the money owed for the first commercial transaction among the plurality of users, allocating to each respective financial account a respective portion of the money owed for the second commercial transaction.

18. The system of claim 17, wherein the processor further is configured to initiate executable operations comprising:
receiving from a server information indicating how respective portions of the money owed for the first commercial transaction were allocated among the plurality of the respective financial accounts.

19. A computer program product for conducting a financial transaction using near field communication, the computer program product comprising:
a computer-readable storage medium having stored thereon program code that, when executed, configures a processor to perform executable operations comprising:
determining an amount of money owed for a first commercial transaction;
receiving from each of a plurality of mobile devices, via near field communication, respective financial account information;
allocating to each respective financial account a respective portion of the money owed for the first commercial transaction, wherein each respective financial account is identified by the financial account information provided by a respective one of the plurality of mobile devices; and
charging, to each of the respective financial accounts, the respective allocated portion of the money owed.

20. The computer program product of claim 19, wherein the executable operations further comprise:
communicating, to each of the mobile devices, a respective receipt indicating a respective amount of money charged in the first commercial transaction to the financial account identified by the financial account information provided by the respective mobile device.
